(19) United States
(12) Patent Application Publication
(10) Pub. No.: US 2018/0193844 A1
(43) Pub. Date: Jul. 12, 2018

(54) STIRRING SYSTEM, STIRRER AND ITS CLAMPING DEVICE

(71) Applicant: Shenzhen China Star Optoelectronics Technology Co., Ltd., Shenzhen, Guangdong (CN)

(72) Inventors: Hui XIA, Shenzhen, Guangdong (CN); Xiang LIU, Shenzhen, Guangdong (CN); Zhichao ZHOU, Shenzhen, Guangdong (CN)

(73) Assignee: Shenzhen China Star Optoelectronics Technology Co. , Ltd., Shenzhen, Guangdong (CN)

(21) Appl. No.: 15/325,078

(22) PCT Filed: Jan. 7, 2017
(86) PCT No.: PCT/CN2017/070533

§ 371 Date: Jan. 9, 2017

(30) Foreign Application Priority Data
Nov. 17, 2016 (CN) 2016110206391

(51) Int. Cl. B01L 9/00; B01F 7/00; B01F 7/16; B01F 13/08; F16B 5/06

(52) U.S. Cl. CPC B01L 9/50; B01F 7/001; B01F 7/0015; B01F 7/161; B01F 2215/0037; B01F 7/00433; B01F 13/089; F16B 5/06; B01F 7/0025

(57) ABSTRACT

The present disclosure provides a stirring system, a stirrer and its clamping device; the clamping device includes: a support link and a clamping mechanism; the clamping mechanism includes a driving unit, a connection assembly and a clamping plate, the driving unit is fixedly connected with the connection assembly and the clamping plate, the clamping plate is used to clamp the experimental product, wherein the driving unit drives the clamping plate to rotate, and drives the experimental product clamped on the clamping plate to rotate. Compared with the prior art, the stirring system, the stirrer and the clamping device provided by the present disclosure can realize the function of fixing and rotating the experimental product during the stirring process by providing a simple clamping device structure, and the structure is reliable and easy to operate, reducing the experimental process of human consumption.

### FIELD OF THE DISCLOSURE

The present disclosure relates to a technology field of a stirring device, and more particularly to a stirring system, a stirrer and a clamping device thereof.

### BACKGROUND OF THE DISCLOSURE

The stirrer serves as an experimental work and equipment commonly used in daily life, take the magnetic stirrer as an example, when the existing magnetic stirrer is working, usually directly with a magnetic and solid-liquid mixture of beaker on the magnetic stirring table, open the magnetic stirring switch for mixing operation. In the process of stirring the magnetic particles and solid particles have a certain resistance, often resulting in the beaker in the mixing process tilt, thus affecting the mixing efficiency, will cause the beaker overturn caused by water bath, oil bath unnecessary pollution, which to the entire experimental operation to bring a lot of inconvenience, sometimes in the experiment in order to avoid the above accidents, the laboratory staff will be from time to time to observe and adjust.

In addition, in some experiments (such as chemical bath deposition experiments), the need to hold the flaky experiment in the beaker in the upright (while the beaker to stir the liquid), or stirring or shaking the way the object of flaky, to ensure that the experimental liquid and the beaker there is relative motion, for the above two cases, the general clamping device in a certain mixing operation easily lead to the drop of experimental products, the current use of artificial methods to solve the above problems, a waste of manpower.

### SUMMARY OF THE DISCLOSURE

In view of the above, an embodiment of the present disclosure provides a stirring system, a stirrer and a clamping device thereof, which solves the technical problem that the stirrer cannot fix and rotate the solid experimental product during stirring in the prior art.

To solve the above problem, the present disclosure provides a clamping device for the experimental of the stirrer, the clamping device includes: a support link and a clamping mechanism; one end of the support link is connected with the top of the stirrer body, the other end is connected with the clamping mechanism; the clamping mechanism includes a driving unit, a connection assembly and a clamping plate, the driving unit is fixedly connected with the connection assembly and the clamping plate, the clamping plate is used to clamp the experimental product, wherein the driving unit drives the clamping plate to rotate, and drives the experimental product clamped on the clamping plate to rotate.

According to a preferred embodiment of the present disclosure, the support link includes a first support link and a second support link, the first support link is connected with the top of the stirrer body, one end of the second support link is connected with the first support link, and the other end is connected with the clamping mechanism.

According to a preferred embodiment of the present disclosure, the height of the first support link is adjustable, and then the second support link is driven to adjust the setting position of the second support link.

According to a preferred embodiment of the present disclosure, the clamping mechanism further includes a connection plate, one end of the connection plate is connected with the driving unit, and the other end is connected with the clamping plate through the connection assembly.

According to a preferred embodiment of the present disclosure, the clamping plate is two pieces, and is sandwiched between both sides of the connection plate, the connection assembly includes a fixed screw and a fixed nut, the fixed screw passes through the two clamping plates and one end of the connection plate, the fixed nut cooperating with the fixed screw to effect the connection between the connection plate and the clamping plate.

According to a preferred embodiment of the present disclosure, the clamping plate is provided with a concavo-convex structure on the inner side of one end of the clamping plate used for clamping the experimental product to increase the nip friction force to the experimental product.

According to a preferred embodiment of the present disclosure, the driving unit includes a drive motor and a motor shaft connected with the drive motor, the motor shaft is connected with the connection plate.

In order to solve the above-mentioned technical problems, the present disclosure also provides a stirrer, the stirrer includes a body and a clamping device as described in any one of the above embodiments, and the clamping device is used for clamping the experimental product and driving the experimental product to rotate.

According to a preferred embodiment of the present disclosure, the stirrer includes a blade stirrer, a ribbon stirrer or a collector type magnetic stirrer.

In order to solve the above-mentioned technical problems, the present disclosure further provides a stirring system, the stirring system includes a container for receiving the substance to be agitated and a stirrer as described in any one of the above embodiments, the stirrer is used to stir the substance to be agitated in the container.

Compared with the prior art, the stirring system, the stirrer and the clamping device provided by the present disclosure can realize the function of fixing and rotating the experimental product during the stirring process by providing a simple clamping device structure, and the structure is reliable easy to operate, reducing the experimental process of human consumption.

### BRIEF DESCRIPTION OF THE DRAWINGS

In order to more clearly illustrate the embodiments or the prior art technical solutions embodiment of the present disclosure, it will implement the following figures for the cases described in the prior art or the need to use a simple introduction. Apparently, the following description the drawings are only some embodiments of the present disclosure, those of ordinary skill in speaking, without creative efforts of the premise, but also can derive other drawings from these drawings.

FIG. 1 is a structure diagram of the composition of a preferred embodiment of the stirring system of the present disclosure;

FIG. 2 is a front view of the structure of the clamping mechanism in the embodiment of the FIG. 1; and

FIG. 3 is a side view of the structure of the clamping mechanism in the embodiment of the FIG. 1.

### DETAILED DESCRIPTION OF PREFERRED EMBODIMENTS

The present disclosure will now be combined with the implementation of the accompanying drawings, were clear examples of technical solutions of the present disclosure, a complete description, it is clear that the described embodiments are merely part of the embodiments of the present disclosure, but not all embodiments. Based on the embodiments of the present disclosure, all other embodiments of the ordinary skill in the absence of creative effort premise obtained, are within the scope of the present disclosure is protected.

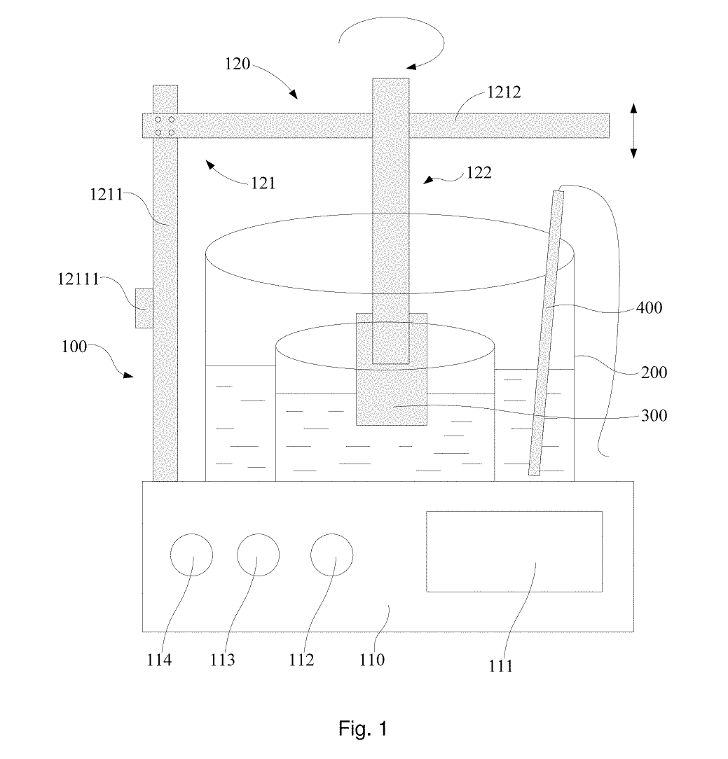

Please refer to FIG. 1, FIG. 1 is a structure diagram of the composition of a preferred embodiment of the stirring system of the present disclosure.

The stirring system including but not limited to a stirrer 100, a container for receiving the substance to be agitated 200, a temperature sensor 400, etc.

The stirrer 100 is used to stir the substance to be agitated in the container 200. The temperature sensor 400 is used to sense the temperature of the water bath liquid in order to control the temperature of the water bath liquid. Wherein, the container 200 may be a beaker or the like.

Is should be noted that the stirrer 100 in the embodiment of the present disclosure may be a blade stirrer, a ribbon stirrer, a collector type magnetic stirrer, or the like, and as will be understood by those skilled in the art, in the present embodiment, only a heat collecting type magnetic stirrer is taken as an example.

Specifically, the stirrer 100 includes a body 110 and a clamping device 120, the clamping device 120 is used for clamping the experimental product 300 and driving the experimental product to rotate.

The stirrer may be provided with a display screen 111, a stirring rate control knob 112, a clamping device rotation rate control knob 113 and a clamping device rotation time control button 114 on the body 110 of the stirrer.

The display screen 111 is used to display the temperature sensed by the temperature sensor 400 and the set temperature, can adjust the set temperature value by touching the screen or the button.

The stirring rate control knob 112 is used to control the speed of the stirrer.

The clamping device rotation rate control knob 113 through the stirrer body 110 internal circuit wires, control body rotation speed of the motor shaft.

The clamping device rotation time control button 114 can be through the internal circuit wires of the stirrer body 110 to control the rotation time of the motor shaft of the stirrer body 110. The structural features of the other parts of the stirrer will not be described in detail herein as understood by those skilled in the art.

The clamping device 120 includes: the support link 121 and the clamping mechanism 122; one end of the support link 121 is connected with the top of the stirrer body 110, the other end is connected with the clamping mechanism 122.

Preferably, the support link 121 includes a first support link 1211 and a second support link 121, the first support link 1211 is connected with the top of the stirrer body 110, and the form of the connection may be a structure connected by a screw or the like. One end of the second support link 121 is connected with the first support link 1211, the other end is connected with the clamping mechanism 122.

Further preferably, the first support link 1211 may also be of a height-adjustable structure, and then the second support link 1212 is driven to adjust the setting height position, i.e. adjust the distance between the experimental product 300 and the beaker.

In the figure, the bidirectional arrow indicates the adjustment of the second support link 1212, and reference numeral 12111 may be an adjustment knob.

Preferably, both the first support link 1211 and the second support link 1212 in the present embodiment employ a hollow tubular structure so that the interior may be configured to accommodate a connection between the motor shaft of the clamping device 120 and the fuselage.

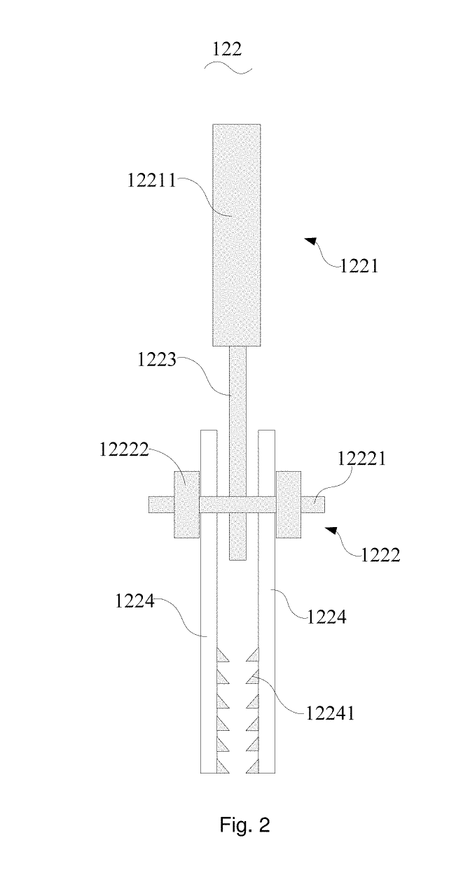

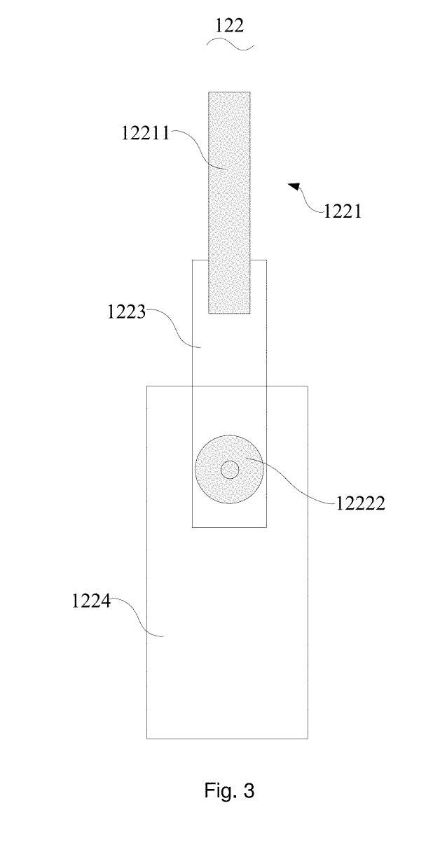

With reference to FIGS. 2 and 3, FIG. 2 is a front view of the structure of the clamping mechanism in the embodiment of the FIG. 1, FIG. 3 is a side view of the structure of the clamping mechanism in the embodiment of the FIG. 1.

The clamping mechanism includes a driving unit 1221, a connection assembly 1222, a connection plate 1223 and a clamping plate 1224.

Wherein, the driving unit 1221 includes a motor (not shown) and a motor shaft connected to the drive motor 12211, the motor shaft 12211 is connected with the connection plate 1223. The other end of the connection plate 1223 is fixedly connected to the clamping plate 1224 through the connection assembly 1222.

Preferably, the clamping plate 1224 is two pieces, one end is clamped on both sides of the connection plate 1223, and the other end is used to clamp the experimental product 300.

The driving unit 1221 is driven by the connecting plate 1223 to drive the clamping plate 1224 to rotate, thereby driving the experimental product clamped on the clamping plate 1224 to rotate.

Wherein, the clamping plate 1224 is provided with a concavo-convex structure 12241 on the inner side of one end of the clamping plate used for clamping the experimental product 300 to increase the nip friction force to the experimental product 300.

Preferably, the concavo-convex structure 12241 may be a saw tooth-like structure, a bump-like structure or other non-smooth planar structure, and is stable in holding the experimental product.

The connection assembly 1222 includes a fixed screw 12221 and a fixed nut 12222, the fixed screw 12221 passes through the two clamping plates 1224 and one end of the connection plate 1223, and the fixed nut 12222 is engaged with the fixed screw 12221.

Wherein, the fixed nut 12222 and the fixed screw 12221 are engaged with each other to provide a connection between the connection plate 1223 and the clamping plate 1224; on the other hand, it is possible to provide the holding force of the two holding plates 1224, by adjusting the tightening degree of the fixing nut 12222 and the fixed screw 12221, so as to achieve the purpose of adjusting the clamping force, the clamping position and the releasing of the two clamping plates 1224 to the experimental product.

In the present disclosure, the fixing nut 12222 may be fitted from both ends of the fixing screw 12221, of course, the nut 12222 may be fitted to one end of the fixing screw 12221 in other embodiments.

Compared with the prior art, the stirring system, the stirrer and the clamping device provided by the present disclosure can realize the function of fixing and rotating the experimental product during the stirring process by providing a simple clamping device structure, and the structure is reliable and easy to operate, reducing the experimental process of human consumption.

The above are only embodiments of the present disclosure is not patented and therefore limit the scope of the present disclosure, the use of any content of the present specification and drawings made equivalent or equivalent structural transformation process, either directly or indirectly in other relevant technical fields are included in the same way the scope of patent protection of the present disclosure.

What is claimed is:

1. An experimental product clamping device for a stirrer, wherein, the clamping device comprises: a support link and a clamping mechanism; one end of the support link is connected with the top of the stirrer body, the other end is connected with the clamping mechanism; the clamping mechanism comprises a driving unit, a connection assembly and a clamping plate, the driving unit is fixedly connected with the connection assembly and the clamping plate, the clamping plate is used to clamp the experimental product, wherein the driving unit drives the clamping plate to rotate, and drives the experimental product clamped on the clamping plate to rotate; the support link comprises a first support link and a second support link, the first support link is connected with the top of the stirrer body, one end of the second support link is connected with the first support link, the other end is connected with the clamping mechanism; the clamping mechanism further comprises a connection plate, one end of the connection plate is connected with the driving unit, the other end is connected with the clamping plate through the connection assembly.

2. The clamping device according to claim 1, wherein, the height of the first support link is adjustable, and then the second support link is driven to adjust the setting position of the second support link.

3. The clamping device according to claim 2, wherein, the clamping plate is two pieces, and is sandwiched between both sides of the connection plate, the connection assembly comprises a fixed screw and a fixed nut, the fixed screw passes through the two clamping plates and one end of the connection plate, the fixed nut cooperating with the fixed screw to effect the connection between the connection plate and the clamping plate.

4. The clamping device according to claim 3, wherein, the clamping plate is provided with a concavo-convex structure on the inner side of one end of the clamping plate used for clamping the experimental product to increase the nip friction force to the experimental product.

5. The clamping device according to claim 1, wherein, the driving unit comprises a drive motor and a motor shaft connected with the drive motor, the motor shaft is connected with the connection plate.

6. A stirrer, wherein, the stirrer comprises a body and a clamping device, the clamping device comprises: a support link and a clamping mechanism; one end of the support link is connected with the top of the body, the other end is connected with the clamping mechanism; the clamping mechanism comprises a driving unit, a connection assembly and a clamping plate, the driving unit is fixedly connected with the connection assembly and the clamping plate, the clamping plate is used to clamp the experimental product, wherein the driving unit drives the clamping plate to rotate, and drives the experimental product clamped on the clamping plate to rotate.

7. The stirrer according to claim 6, wherein, the stirrer comprises a blade stirrer, a ribbon stirrer or a collector type magnetic stirrer.

8. The stirrer according to claim 6, wherein, the support link comprises a first support link and a second support link, the first support link is connected with the top of the stirrer body, one end of the second support link is connected with the first support link, the other end is connected with the clamping mechanism.

9. The stirrer according to claim 8, wherein, the height of the first support link is adjustable, and then the second support link is driven to adjust the setting position of the second support link.

10. The stirrer according to claim 6, wherein, the clamping mechanism further comprises a connection plate, one end of the connection plate is connected with the driving unit, the other end is connected with the clamping plate through the connection assembly.

11. The stirrer according to claim 10, wherein, the clamping plate is two pieces, and is sandwiched between both sides of the connection plate, the connection assembly comprises a fixed screw and a fixed nut, the fixed screw passes through the two clamping plates and one end of the connection plate, the fixed nut cooperating with the fixed screw to effect the connection between the connection plate and the clamping plate.

12. The stirrer according to claim 11, wherein, the clamping plate is provided with a concavo-convex structure on the inner side of one end of the clamping plate used for clamping the experimental product to increase the nip friction force to the experimental product.

13. The stirrer according to claim 10, wherein, the driving unit comprises a drive motor and a motor shaft connected with the drive motor, the motor shaft is connected with the connection plate.

14. A stirring system, wherein, the stirring system comprises a container for receiving the substance to be agitated and a stirrer, the stirrer is used to stir the substance to be agitated in the container; the stirrer comprises a body and a clamping device, the clamping device comprises: a support link and a clamping mechanism; one end of the support link is connected with the top of the body, the other end is connected with the clamping mechanism; the clamping mechanism comprises a driving unit, a connection assembly and a clamping plate, the driving unit is fixedly connected with the connection assembly and the clamping plate, the clamping plate is used to clamp the experimental product, wherein the driving unit drives the clamping plate to rotate, and drives the experimental product clamped on the clamping plate to rotate.

15. The stirring system according to claim 14, wherein, the support link comprises a first support link and a second support link, the first support link is connected with the top of the stirrer body, one end of the second support link is connected with the first support link, and the other end is connected with the clamping mechanism.

16. The stirring system according to claim 15, wherein, the height of the first support link is adjustable, and then the second support link is driven to adjust the setting position of the second support link.

17. The stirring system according to claim 16, wherein, the clamping mechanism further comprises a connection plate, one end of the connection plate is connected with the driving unit, the other end is connected with the clamping plate through the connection assembly.

18. The stirring system according to claim 17, wherein, the clamping plate is two pieces, and is sandwiched between both sides of the connection plate, the connection assembly comprises a fixed screw and a fixed nut, the fixed screw passes through the two clamping plates and one end of the connection plate, the fixed nut cooperating with the fixed screw to effect the connection between the connection plate and the clamping plate.

19. The stirring system according to claim 18, wherein, the clamping plate is provided with a concavo-convex structure on the inner side of one end of the clamping plate used for clamping the experimental product to increase the nip friction force to the experimental product.

20. The stirring system according to claim 19, wherein, the driving unit comprises a drive motor and a motor shaft connected with the drive motor, the motor shaft is connected with the connection plate.
